(19) United States
(12) Patent Application Publication
(10) Pub. No.: US 2025/0362266 A1
(43) Pub. Date: Nov. 27, 2025

(54) REGENERATION OF A CHEMICAL SENSOR

(71) Applicants: SERINUS LABS, INC, Berkeley, CA (US); THE REGENTS OF THE UNIVERSITY OF CALIFORNIA, Oakland, CA (US)

(72) Inventors: David William Gardner, Richmond, CA (US); Hossain M. Fahad, Berkeley, CA (US); Ali Javey, Lafayette, CA (US); Gordon M. Charles, Sunnyvale, CA (US)

(73) Assignees: SERINUS LABS, INC, Berkeley, CA (US); THE REGENTS OF THE UNIVERSITY OF CALIFORNIA, Oakland, CA (US)

(21) Appl. No.: 18/670,230

(22) Filed: May 21, 2024

(51) Int. Cl. G01N 27/416; G01N 27/414; H01M 10/42

(52) U.S. Cl. CPC G01N 27/416; G01N 27/414; H01M 10/4285

(57) ABSTRACT

A sensor regeneration system includes a primary chemical sensor arranged in a confined environment and configured to detect the presence of a chemical substance. The system also includes a first heating element arranged proximate the primary chemical sensor and configured to generate thermal energy to increase the temperature of the primary chemical sensor. The system additionally includes a first temperature sensor arranged proximate the primary chemical sensor and configured to detect the temperature of the primary chemical sensor. The system further includes an electronic control unit (ECU) in operative communication with the primary chemical sensor, the first heating element, and the first temperature sensor. The ECU is configured to regenerate the primary chemical sensor at a predefined regeneration temperature via the first heating element when the primary chemical sensor is not detecting presence of the chemical substance.

### GOVERNMENT LICENSE RIGHTS

This invention was made with United States Government support under SBIR Phase II program contract No.: 2112273 awarded by the National Science Foundation. The United States Government has certain rights in this invention.

### INTRODUCTION

The present disclosure generally relates to regeneration of sensors employed to continuously monitor an environment for the presence of chemical substances, such as gases.

A sensor is a device that produces an output signal for the purpose of sensing a physical phenomenon. In the broadest definition, a sensor is a device, module, machine, or subsystem that detects events or changes in its environment and sends the information to other electronics, frequently a computer processor. Sensors are usually designed to have a small effect on what is measured; making the sensor smaller often improves this characteristic and may introduce other advantages.

With advances in micromachinery and easy-to-use microcontroller platforms, the uses of sensors have expanded beyond the traditional fields of temperature, pressure, and flow measurement, for example into microchip-based integrated circuit sensors. In most cases, microchip-based sensors reach a significantly faster measurement time and higher sensitivity compared with macroscopic approaches. Microchip-based sensors may, for example, be used for detecting concentrations of chemical substances, such as gases vented by battery cells in energy storage systems.

Microchip-based sensors for detecting chemicals are by necessity exposed to various substances and contaminants present in the ambient environment. Over time, chemical impurities or dust may affect the sensor's response to a target chemical substance by being adsorbed on the surface of the sensor. Such adsorbates may be removed in a way that returns the sensor to near original state and improves or restores the sensor's performance. The restoration of the sensor from a state clouded with adsorbates to its original state is called a regeneration.

### SUMMARY

A sensor regeneration system includes a primary chemical sensor arranged in a confined environment and configured to detect the presence of a chemical substance. The system also includes a first heating element arranged proximate the primary chemical sensor and configured to generate thermal energy to increase the temperature of the primary chemical sensor. The system additionally includes a first temperature sensor arranged proximate the primary chemical sensor and configured to detect the temperature of the primary chemical sensor. The system further includes an electronic control unit (ECU) in operative communication with the primary chemical sensor, the first heating element, and the first temperature sensor. The ECU is configured to regenerate the primary chemical sensor at a predefined regeneration temperature via the first heating element when the primary chemical sensor is not detecting presence of the chemical substance.

In one aspect, the ECU may be configured, i.e., constructed and programmed, to activate the first heating element periodically, at a predetermined time interval, to increase the temperature of the primary chemical sensor up to the predefined regeneration temperature. Such activation of the first heating element is intended to periodically regenerate the primary chemical sensor.

In another aspect, the ECU may be configured to monitor the temperature of the primary chemical sensor via the first temperature sensor and operation of the first heating element. The ECU is also configured to ascertain the presence of a contaminant on the primary chemical sensor using the monitored temperature of the primary chemical sensor and operation of the first heating element. The ECU is additionally configured to activate the first heating element to increase the temperature of the primary chemical sensor up to the predefined regeneration temperature for a predetermined period of time in response to the ascertained presence of the contaminant. The regeneration temperature extended for the predetermined period of time is intended to remove or burn off the contaminant and thereby regenerate the primary chemical sensor.

The first heating element may be configured to increase temperature of the primary chemical sensor to a target operating or sensing temperature and thereby enable detection of the chemical substance.

The ECU may be also configured to ascertain the presence of the contaminant on the primary chemical sensor via assessing the heating efficiency of the first heating element. Specifically, such an assessment of the first heating element's heating efficiency may be accomplished via determining an amount of electrical energy consumed by the first heating element to increase the temperature of the primary chemical sensor to the target operating temperature and comparing the determined amount to a predetermined threshold amount.

An empirically generated look-up table of threshold amounts of electrical energy consumed by the first heating element in reaching its target operating temperature versus the primary chemical sensor's starting temperatures may be programmed into the controller for assessing the heating efficiency of the first heating element.

The ECU may be additionally configured to monitor over time the amount of electrical energy consumed by the first heating element to increase the temperature of the primary chemical sensor to the target operating temperature. The ECU may be further configured to activate the first heating element to remove the contaminant from the primary chemical sensor when the amount of electrical energy consumed by the first heating element to increase the temperature of the primary chemical sensor to the target operating temperature is greater than a predefined threshold amount of energy. The predefined threshold amount of energy may be programmed into the ECU.

The ECU may be additionally configured to determine the temperature detected by the first temperature sensor using a relationship between electrical resistance of the first temperature sensor and the temperature of the primary chemical sensor programmed into the ECU.

Each of the first temperature sensor and the first heating element may include an operative component constructed from a non-oxidizing material selected from platinum (Pt), gold (Au), silver (Ag), titanium nitride (TiN), polycrystalline silicon (Si), Tungsten (W), Tantalum Nitride (TaN), and combinations thereof.

The regeneration temperature is higher than primary chemical sensor target operating temperature. The predefined regeneration temperature may be at least 100 degrees Celsius.

The sensor regeneration system may additionally include a contaminant sensor in operative communication with the ECU. Such a contaminant sensor may be configured to monitor the confined environment for presence of the contaminant and detect and communicate to the ECU presence of a predefined concentration of the contaminant in the confined environment. The ECU may be configured to activate the first heating element to increase the temperature of the primary chemical sensor up to the predefined regeneration temperature in response to the detected presence of the predefined concentration of the contaminant.

The contaminant sensor may include a second heating element and a second temperature sensor. In such an embodiment, the ECU may be additionally configured to regenerate the contaminant sensor via the second heating element, such as when the primary chemical sensor is detecting presence of the chemical substance.

The primary chemical sensor may be one of a plurality of silicon chemical-sensitive field effect transistors (CS-FETs) arranged on a sensor array microchip. Each of the CS-FETs may be configured to detect one of multiple distinct gases vented by a lithium-ion battery cell. In such an embodiment, the ECU may be in operative communication with the sensor array microchip to monitor and regenerate each respective CS-FET.

A method of monitoring and regenerating a chemical sensor is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic view of a sensor regeneration system including an electronic control unit (ECU) in operative communication with a primary chemical sensor accompanied by a first heating element and a first temperature sensor and a contaminant sensor accompanied by a second heating element and a second temperature sensor, according to the present disclosure.

FIG. 2 is a circuit diagram of a multi-cell rechargeable energy storage system (RESS) having rechargeable lithium-ion (Li-ion) battery cells connected to a battery management system (BMS) equipped with sensor array microchips using silicon chemical-sensitive field effect transistors (CS-FETs) for detecting multiple distinct gases vented by the battery cells and contaminant CS-FETs, according to the present disclosure.

FIG. 3 is a schematic top view of an individual microchip shown in FIG. 2, depicting a plurality of CS-FETs along with heating elements and temperature sensors, according to the present disclosure.

FIG. 4 is a schematic cross-sectional side view of the microchip shown in FIG. 3, depicting an embodiment of one of the individual CS-FETs with contaminant particles, according to the present disclosure.

FIG. 5 illustrates a method of monitoring and regenerating a chemical sensor shown in FIGS. 1-4.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

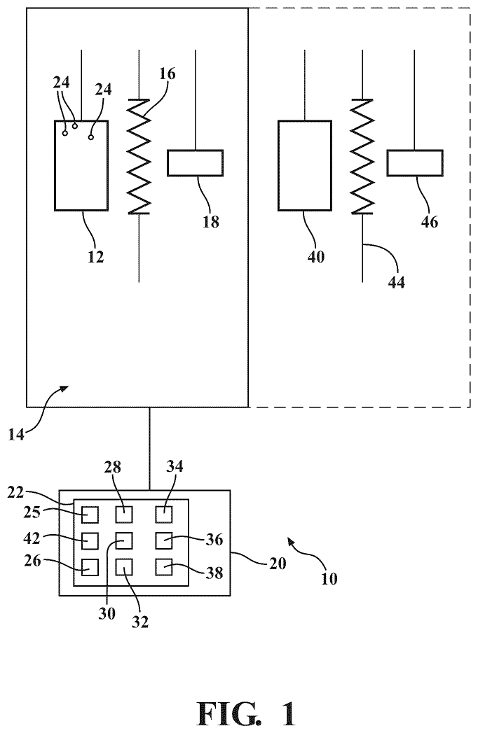

Referring to FIG. 1, a sensor regeneration system 10 is shown. The sensor regeneration system 10 is specifically intended to enable substantial restoration of a chemical sensor's performance by removing adsorbates from the sensor's surface without removing the subject sensor from its operational environment. The sensor regeneration system 10 includes a primary chemical sensor 12 arranged in a confined environment 14 and configured to detect the presence of a chemical substance, such as a gas. Specifically, the primary chemical sensor 12 may incorporate a catalyst responsive to the subject chemical substance. The sensor regeneration system 10 also includes a first heating element 16, such as a micro-heater, positioned in the confined environment 14. Specifically, the first heating element 16 is arranged proximate or mounted to the primary chemical sensor 12 and configured to generate thermal energy to increase the temperature of the primary chemical sensor. For example, the first heating element 16 may be configured to increase the operating temperature of the primary chemical sensor's catalyst (such as from ambient temperature) to enable detection of the chemical substance.

The sensor regeneration system 10 additionally includes a first temperature sensor 18 similarly positioned in the confined environment 14. The first temperature sensor 18 is arranged proximate or mounted to the primary chemical sensor 12 and configured to detect temperature of the primary chemical sensor. The first temperature sensor 18 may detect the operating temperature of the primary chemical sensor 12 to determine whether the first heating element 16 should be activated to increase the primary chemical sensor's operating temperature. Each of the first heating element 16 and the first temperature sensor 18 may include an operative component constructed from a non-oxidizing material selected from platinum (Pt), gold (Au), silver (Ag), titanium nitride (TiN), polycrystalline silicon (Si), Tungsten (W), Tantalum Nitride (TaN), and combinations thereof.

With continued reference to FIG. 1, the sensor regeneration system 10 further includes an electronic control unit (ECU) 20 in operative communication with the primary chemical sensor 12, the first heating element 16, and the first temperature sensor 18. The primary chemical sensor 12, the first heating element 16, and the first temperature sensor 18 may be physically wired to the ECU 20 or communicate with the ECU wirelessly. ECU 20 is intended to include a processor and tangible, non-transitory memory, with instructions for managing operation of the primary chemical sensor 12 programmed therein. The ECU's memory may be an appropriate recordable medium that participates in providing computer-readable data or process instructions. Such a recordable medium may take many forms, including but not limited to non-volatile media and volatile media.

Non-volatile media for the ECU 20 may include persistent memory accessible via appropriate memory instructions. Volatile media may include, for example, dynamic random-access memory (DRAM), which may constitute a main memory. The instructions programmed into the ECU 20 may be transmitted by an appropriate transmission medium, such as wiring and fiber optics, or via a wireless connection. The ECU 20 may be equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithm(s), indicated generally via numeral 22, required by the ECU 20 or accessible thereby may be programmed into the ECU, stored within its memory, and automatically executed to facilitate operation of the first temperature sensor 18.

The ECU 20 is typically configured, i.e., constructed and programmed, to receive a signal generated by the primary chemical sensor 12 indicative of a detected amount of corresponding chemical substance. The algorithm(s) 22 also include instructions to compare the detected amount of the chemical substance to a predetermined threshold amount of the subject chemical substance programmed into the ECU 20. The algorithm(s) 22 may include further instructions to trigger a signal indicative of a critical condition in the confined environment 14, such as an impending failure of the monitored battery cell, when the detected amount of the subject chemical substance exceeds the predetermined threshold amount.

The algorithm(s) 22 also include an inventory mode configured to monitor the primary chemical sensor 12 and/or interrogate the primary chemical sensor at predetermined time intervals to verify effective line of communication with and operation of the primary chemical sensor. Algorithm(s) 22 additionally include instructions to perform regeneration of the primary chemical sensor 12. Specifically, the ECU 20 is configured to monitor the temperature of the primary chemical sensor 12 via the first temperature sensor 18 and monitor operation of the first heating element 16. The ECU 20 is also configured to ascertain presence of an adsorbate or contaminant 24 on the primary chemical sensor 12 using the monitored temperature of the primary chemical sensor and operation of the first heating element 16. Contaminant 24 may be a dust particle, a charged particle, moisture, or water vapor, etc. that negatively affects detection sensitivity of the primary sensor 12. The ECU 20 may be configured to determine, i.e., decode or interpret, the temperature detected by the first temperature sensor 18 using a relationship 25 between electrical resistance of the first temperature sensor and the temperature of the primary chemical sensor 12 programmed into the ECU.

The ECU 20 may be configured to activate or pulse the first heating element 16 periodically, at a predetermined time interval 26, to regenerate the primary chemical sensor 12 by heating the subject sensor at each pulse instance or cumulatively to a predefined regeneration temperature 28. The predetermined time interval 26 may be 60 seconds or a greater timeframe. Alternatively, the ECU 20 may be configured to activate the first heating element 16 in response to the ascertained presence of the contaminant 24 and heat the primary chemical sensor 12 up to the predefined regeneration temperature 28. The predefined regeneration temperature 28 may be at least 100 degrees and up to 300+degrees Celsius.

ECU 20 activates the first heating element 16 for a predetermined period of time 30 when the primary chemical sensor 12 is not detecting presence of the chemical substance. Activation of the first heating element 16 for the predetermined period of time 30 causing the primary chemical sensor 12 to reach the predefined regeneration temperature 28 is intended to remove or burn off the contaminant 24 and thereby regenerate the primary chemical sensor. The predetermined period of time 30 may be in the range of 0.1 seconds-10 minutes. Specific regeneration temperature 28 and the period of time 30 values may be determined empirically during testing of a particular primary sensor 12 and programmed into the ECU 20.

As noted above, to facilitate regular operation of the primary chemical sensor 12, i.e., detection of the chemical substance, the first heating element 16 may preemptively increase the primary chemical sensor's temperature. Specifically, the ECU 20 may be programmed to raise the temperature of the primary chemical sensor 12 to a target operating or sensing temperature 32, which is lower than the regeneration temperature 28. Also, the ECU 20 may be configured to ascertain the presence of the contaminant 24 on the primary chemical sensor 12 via determining whether the efficiency of the first heating element 16 in heating the primary chemical sensor is within an acceptable range. For example, ECU 20 may be programmed to determine an amount 34 of electrical power or energy consumed by the first heating element 16 to increase the temperature of the primary chemical sensor 12 to the target operating temperature 32. The ECU 20 may then compare the determined consumed amount 34 to a predetermined threshold amount 36 of consumed electrical energy. If the heating efficiency of the first heating element 16 is determined to be outside of the acceptable range, regeneration of the first heating element 16 will be triggered.

The ECU 20 may be programmed to monitor, continuously or periodically, the electrical energy amount 34 being consumed by the first heating element 16 to raise the temperature of the primary chemical sensor to the target operating temperature 32. The ECU 20 may be programmed with the predefined threshold amount 36 of the electrical energy that may be consumed by the first heating element 16 in reaching the target operating temperature 32. The ECU 20 may be further configured to activate the first heating element 16 to remove the contaminant 24 from the primary chemical sensor 12 when the amount 34 of electrical energy consumed by the first heating element in reaching the target operating temperature 32 is greater than the predefined threshold amount 36 of energy.

The amount of electrical energy consumed by the first heating element 16 to achieve the target operating temperature 32 may depend on the ambient temperature or the “cold” temperature of the primary chemical sensor 12 (sensor's starting temperature prior to activation of the first heating element 16). To account for such dependency, an empirically generated look-up table 38 may be programmed into the ECU 20. The look-up table 38 may include values of the threshold amount 36 of electrical energy consumed by the first heating element 16 to achieve the target operating temperature 32 versus ambient temperature values or the cold temperature values of the primary chemical sensor 12. The ECU 20 may be programmed to compare the determined amount 34 of electrical energy consumed by the first heating element 16 to a corresponding threshold amount 36 provided in the table 38 to initiate removal of the contaminant 24 from the primary chemical sensor 12 via the first heating element 16. Alternatively, the amount of electrical energy consumed 34 by the first heating element 16 may be evaluated versus the predefined threshold amount 36 in terms of an amount of power per unit temperature for assessing the heating efficiency of the first heating element 16.

As also shown in FIG. 1, the sensor regeneration system 10 may include a contaminant sensor 40 in communication with the ECU 20. The contaminant sensor 40 may be structured similarly to the primary chemical sensor 12 but specifically configured to detect chemical substance(s), such as dust, moisture, charged particles, or water vapor, etc., which may constitute the contaminant 24. Contaminant sensor 40 is constructed such that the target chemical substance to be detected by the primary chemical sensor 12 does not induce a response in the contaminant sensor. The contaminant sensor 40 may be used to monitor the confined environment 14 for the presence of the contaminant(s) 24 and communicate to the ECU 20 when a predefined concentration 42 thereof is detected. In response to the detection of the predefined concentration 42, ECU 20 may trigger regeneration of the primary chemical sensor 12. ECU 20 may trigger regeneration of the primary chemical sensor 12 periodically, i.e., at regular time intervals, or shorten the time intervals when a contaminated environment is detected by the contaminant sensor 40. (Is a single contaminant sensor adequate for this?) The contaminant sensor 40 may include a second heating element 44 and a second temperature sensor 46, which may have identical structures to the respective first heating element 16 and first temperature sensor 18. The ECU 20 may be further configured to regenerate the contaminant sensor 40 via the second heating element 44 when the primary chemical sensor 12 is detecting presence of the chemical substance.

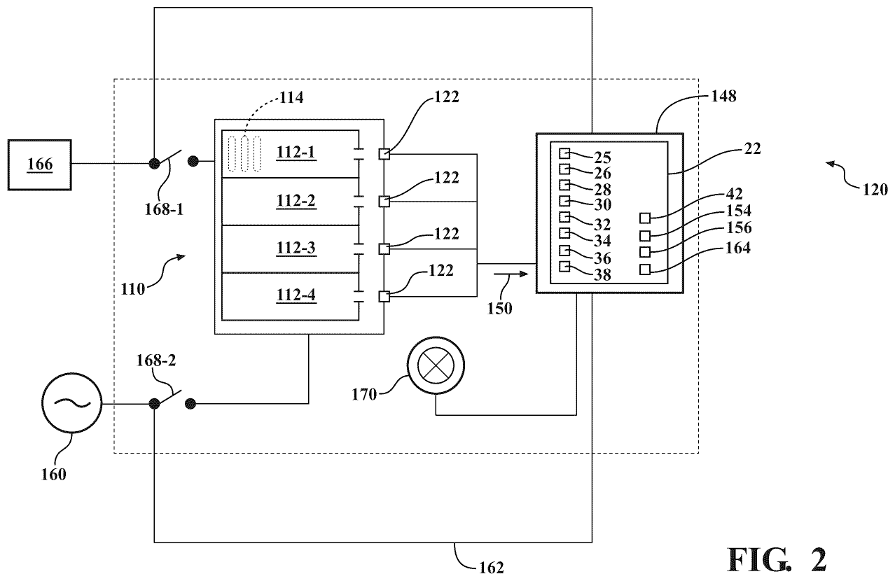

A Schottky diode, a transistor, or a capacitor are at least some of the nonlimiting examples of the subject primary chemical sensor 12. A silicon chemical-sensitive field effect transistor (CS-FET) embodiment of the primary chemical sensor 12 will be discussed in detail below. Such CS-FETs may be employed in a battery management system (BMS) for operating a multi-cell rechargeable energy storage system (RESS) 110 (shown in FIG. 2). As shown, the RESS 110 includes individual battery modules, shown as four modules 112-1, 112-2, 112-3, 112-4, each having one or more rechargeable lithium-ion battery cells 114. The RESS 110 is configured to generate and store electrical energy through heat-producing electro-chemical reactions for supplying the electrical energy to power an electrical load.

In the battery modules having a plurality of Lithium ion (Li-ion) cell battery cells 114, the subject cells may be arranged, i.e., connected, either in series or in parallel. A plurality of such modules may then be arranged in a battery pack as part of the RESS 110. Although four modules 112-1, 112-2, 112-3, 112-4 are shown, nothing precludes the RESS 110 from having a greater number of such battery modules. A generalized version of the RESS 110 shown in FIG. 1, with its Li-ion battery cells 114, may be used to power various products, for example, electric vehicles and consumer electronic devices, such as smartphones and laptops.

As shown, the RESS 110 is operatively connected to a battery management system (BMS) 120. The BMS 120 is configured to regulate operation of the RESS 110, and, particularly, to detect malfunction and impending failure of the Li-ion battery cell(s) 114. In other words, the BMS 120 is designed and constructed to perform early detection of, as well as issue a warning regarding malfunction and/or failure of Li-ion battery cell(s) 114. When undergoing high internal reaction rates, lithium-ion battery cells 114 may generate significant amounts of thermal energy, which may lead to a thermal runaway event and catastrophic cell failure. In general, the term “thermal runaway event” refers to an uncontrolled increase in temperature in a battery system.

During a thermal runaway event, the generation of heat within a battery system or a battery cell exceeds the dissipation of heat, thus leading to a further increase in temperature. Generally, a thermal runaway event may be triggered by various conditions, including a short circuit within the cell, improper cell use, physical abuse, manufacturing defects, or exposure of the cell to extreme external temperatures. Li-ion battery cells, such as the battery cells 114, are particularly known to emit or vent gases such as hydrogen (H₂), carbon dioxide (CO₂), carbon monoxide (CO), ethylene (C₂H₄) while undergoing a thermal chain reaction, in advance to catastrophic battery failure.

With resumed reference to FIG. 2, the BMS 120 includes one or more multi-gas sensor array system on chips (SoC) or microchips 122 (shown in FIGS. 2-4). Each microchip 122 may be arranged proximate to a particular Li-ion battery cell 114, as shown in FIG. 2. As noted above, the Li-ion battery cell 114 may be part of an RESS 110 having a plurality of analogous Li-ion battery cells 114 arranged in individual battery modules. Accordingly, in such an embodiment, the BMS 120 may include multiple microchips 122, one microchip for each battery cell 114, for example. Alternatively, each of the microchips 122 may be arranged in a central position relative to or inside an individual battery module 112-1, 112-2, 112-3, 112-4 to detect multiple distinct gases vented by the Li-ion battery cell 114 on a module level. In other words, in such an embodiment each microchip 122 may be arranged to detect gases vented by one or a plurality of Li-ion battery cells 114 situated in a particular battery module.

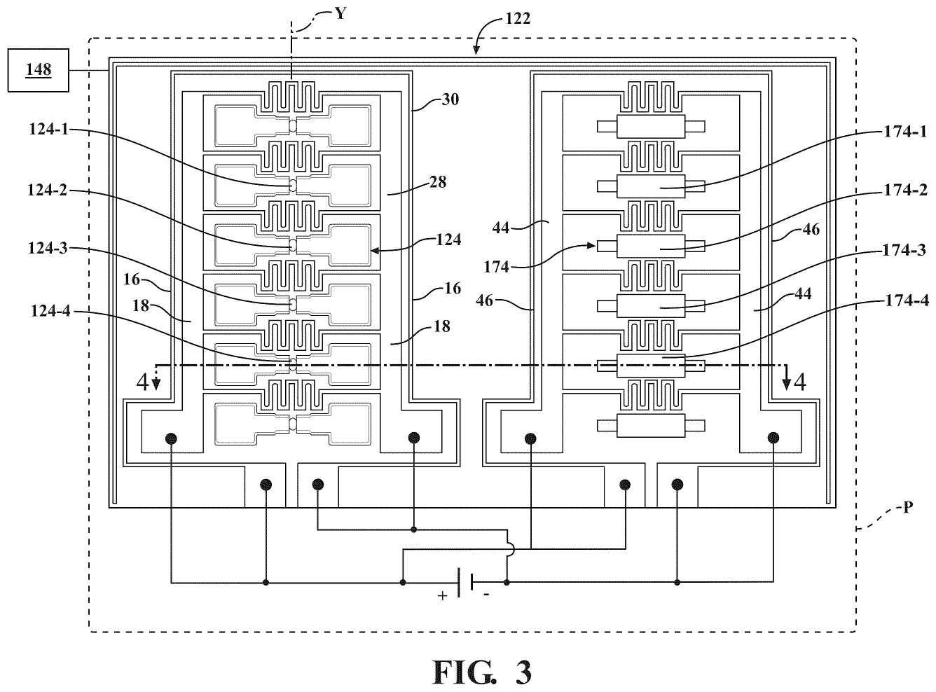

As shown in FIG. 3, the microchip 122 includes a plurality of silicon chemical-sensitive field effect transistors (CS-FETs) 124, which may be arranged side by side in a reference plane P along a microchip longitudinal axis Y. The CS-FETs 124 are configured to detect functionally significant amounts of multiple chemically distinct gases vented by the Li-ion battery cell(s) 114. Each of the individual CS-FETs 124 is configured to detect one of the distinct gases vented by the Li-ion battery cell 114. Each CS-FET 124 may be a particular embodiment of the primary chemical sensor 12 discussed above with respect to FIG. 1. Accordingly, although multiple CS-FETS 124 are depicted as part of the microchip 122, an individual CS-FET configured to detect a particular gas in an environment, e.g., the confined environment 14, separate from the RESS 110 and emitted other than by a Li-ion battery cell 114 is also contemplated.

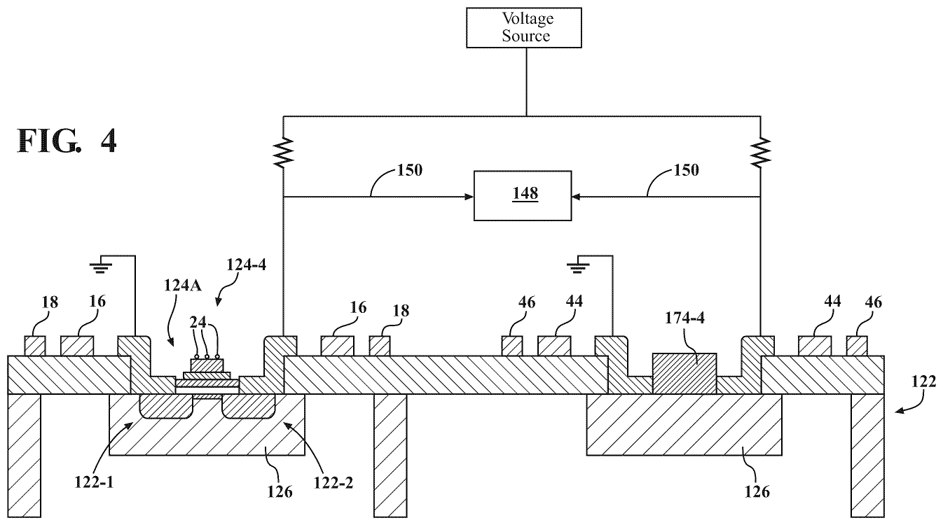

Each individual CS-FETs 124 on the microchip 122 is differentiated from the other CS-FETs by a distinct nano-material catalyst assembly, depicted in FIG. 3 as assemblies 124-1, 124-2, 124-3, and 124-4. In a cross-sectional plane 4-4 indicated in FIG. 3, FIG. 4 specifically depicts a schematic section of an individual assembly 124-4 mounted on the microchip 122 mounted in its respective sensor channel 124A. Within a single CS-FET 124, the nano-material catalyst assembly, either 124-1, 124-2, 124-3, or 124-4, is responsible for interaction with the vented gas. The respective nano-material catalyst assemblies 124-1, 124-2, 124-3, and 124-4 may include metals like platinum (for detecting C₂H₄ gas), palladium-platinum (for detecting CO gas), or mixtures of metals like nickel-palladium (for detecting H₂ gas), and gold-copper (for detecting CO₂ gas).

As shown in a cross-sectional view in FIG. 4, the microchip 122 includes a silicon transistor body or substrate 126 configured to support the respective nano-material catalyst assemblies 124-1, 124-2, 124-3, and 124-4. As additionally shown, the silicon transistor substrate 126 forms localized silicon islands to support a plurality of source electrodes or terminals 122-1, one for each nano-material catalyst assembly 124-1, 124-2, 124-3, and 124-4, connected to ground. The silicon transistor substrate 126 also supports a plurality of drain terminals or electrodes 122-2, each connecting a respective nano-material catalyst assembly 124-1, 124-2, 124-3, and 124-4 to a power source, via a digital or an analog converter (not shown). Channel 124A is situated between the CS-FET's corresponding source and drain terminal 122-1, 122-2 and operates as a current carrying region between the subject terminals. In each CS-FET 124, the respective sensor channel 124A is bracketed by the corresponding source terminal 122-1 and drain terminal 122-2.

The nano-material catalyst assemblies 124-1, 124-2, 124-3, and 124-4 are electrically isolated from one another and are not connected to an electric voltage source. Each nano-material catalyst assembly 124-1, 124-2, 124-3, and 124-4 is specifically configured to interact with and detect a specific gas without interference from other gases as a result of the subject catalyst's particular material properties. The source electrode 122-1 supplies the charge carriers to the sensor channel 124A. The drain electrode 122-2 collects or drains charge carriers or electrons. Charge carriers generally flow from the source electrode 122-1 to the drain electrode 122-2 upon application of a voltage across the drain to the source. The flow of charge carriers is regulated by the amount of voltage applied to the corresponding nano-material catalyst assembly 124-1, 124-2, 124-3, and 124-4, and the nano-material catalyst assembly in turn controls the flow of charge carriers between the source electrode 122-1 and the drain electrode 122-2. A chemical interaction of a specific gas with a respective nano-material catalyst changes the surface charge on subject catalyst, leading to a detection event of the vented gas.

Analogous to the primary chemical sensor 12, each individual CS-FET 124 may also include the first heating element 16 and the first temperature sensor 18. The first heating element 16 is configured to generate thermal energy to increase temperature of the host CS-FET 124 and the first temperature sensor 18 is configured to detect temperature of the subject CS-FET. For example, the first heating element 16 may be configured to increase operating temperature of the host CS-FET 124 to enable detection of the corresponding gas. The first temperature sensor 18 may detect the temperature of the host CS-FET 124 to determine whether the first heating element 16 should be activated to heat the host CS-FET. As shown in FIG. 4, each CS-FET 124 may include a plurality of first heating elements 16 and temperature sensors 18, each arranged around the periphery of the subject CS-FET.

With reference to FIGS. 2-4, the BMS 120 also includes an electronic cell monitoring unit (CMU) 148 in operative communication with the CS-FETs 124. The CMU 148 may be part of a battery controller network (not shown) configured to manage operation of the battery modules, e.g., modules 112-1, 112-2, 112-3, 112-4. Among various communication, processing, and management functions, the CMU 148 is configured, i.e., constructed and programmed, to receive from the CS-FETs 124 data 150 via a signal indicative of the detected amount or level of at least one of the gases vented by the Li-ion battery cell(s) 114. The CMU 148 may be a particular embodiment of, and thus include the functions of ECU 20 discussed above with respect to FIG. 1.

Specifically, the CMU 148 may include the algorithm(s) 22 responsible for regeneration of each CS-FET 124 in BMS 120. Alternatively, the CMU 148 may have a central or hub controller structure in operative communication with a plurality of such ECUs 20 (either physically wired or communicating wirelessly), wherein each ECU controls operation of an individual CS-FET 124. Accordingly, BMS 120 may possess sensor monitoring and regeneration functions analogous to those of the previously described sensor regeneration system 10. For example, in response to ascertained presence of the contaminant 24 on an individual CS-FET 124, the corresponding first heating element 16 may be activated to increase the subject CS-FET's temperature up to the predefined regeneration temperature 28.

The CMU 148 is configured to compare the received vented gas data 150 to a respective predetermined threshold amount 154 of the subject vented gas. The specific gases vented by the battery cell(s) 114 and detected by the corresponding CS-FET may include ethylene (C₂H₄), hydrogen (H₂), carbon dioxide (CO₂), and carbon monoxide (CO). As shown in FIG. 2, the CMU 148 is additionally configured to trigger a signal 156 indicative of the detected battery fault, predictive of an impending failure of the Li-ion battery cell(s) 114, and potentially leading to a thermal runaway, when the detected amount(s) of the gases(s) vented by the lithium-ion battery cell exceeds the predetermined threshold vented amount 154. The signal 156 may be an audible and/or visual sensory signal or alert. Particularly, when employed in a motor vehicle, the RESS 110 may be connected to an electrical load 160 and to the CMU 148 via a high-voltage BUS 162 (shown in FIG. 2). The CMU 148 may be additionally configured to command a corrective or remedial action 164, including, for example, disconnecting the Li-ion battery cell(s) 114 from a battery charger 166 or from the electrical load 160, such as by opening a respective switch 168-1, 168-2, or enabling a fire suppression system 170.

The BMS 120 may also include multiple CS-FET contaminant sensors 174. As shown in FIG. 3, each microchip 122 may include one or more such CS-FET contaminant sensors 174, depicted as assemblies 174-1, 174-2, 174-3, and 174-4. Each CS-FET contaminant sensor 174 is an embodiment of the contaminant sensor 40 described above with respect to FIG. 1. Accordingly, each CS-FET contaminant sensor 174 corresponds, i.e., is configured as a counterpart, to one of the CS-FETs 124 and is positioned spatially near the same. Each CS-FET contaminant sensor 174 is configured to monitor the confined environment 14 for presence of the contaminant 24. Furthermore, each contaminant CS-FET sensor 174 is constructed such that the target gas to be detected by the counterpart CS-FET 124 does not induce a response in the subject contaminant sensor.

The CS-FET contaminant sensors 174 may be employed by the BMS 120 for controlling the RESS 110 and be in operative communication with the CMU 148. The contaminant CS-FETs 174 may communicate to the CMU 148 when a predefined concentration 42 of a particular contaminant 24 is detected. In response to the detection of the predefined concentration 42, the CMU 148 may trigger regeneration of the corresponding CS-FET 124. Analogous to the described contaminant sensor 40, each contaminant CS-FET 174 may include the second heating element 44 and the second temperature sensor 46. Each contaminant CS-FET 174 may be regenerated by the BMS 120 using its second heating element 44, for example when the corresponding CS-FET 124 is detecting presence of the respective gas.

Overall, the system controller, such as the ECU 20 or the CMU 148, is configured to regenerate the primary chemical sensor 12, e.g., its embodiment CS-FET 124, by increasing the temperature of the primary chemical sensor to burn off contaminant(s) 24 thereon when the subject chemical sensor is not operating in detection mode. Such regeneration may be performed automatically at regular intervals or be based on the presence of a contaminant on the primary chemical sensor established using the primary sensor's monitored operating parameters. Additionally, a contaminant sensor 40, e.g., its embodiment contaminant CS-FET 174, may be used for detection of the contaminant(s) to trigger regeneration of the primary chemical sensor. The contaminant sensor 40 itself may be regenerated when the counterpart primary chemical sensor is operating in detection mode.

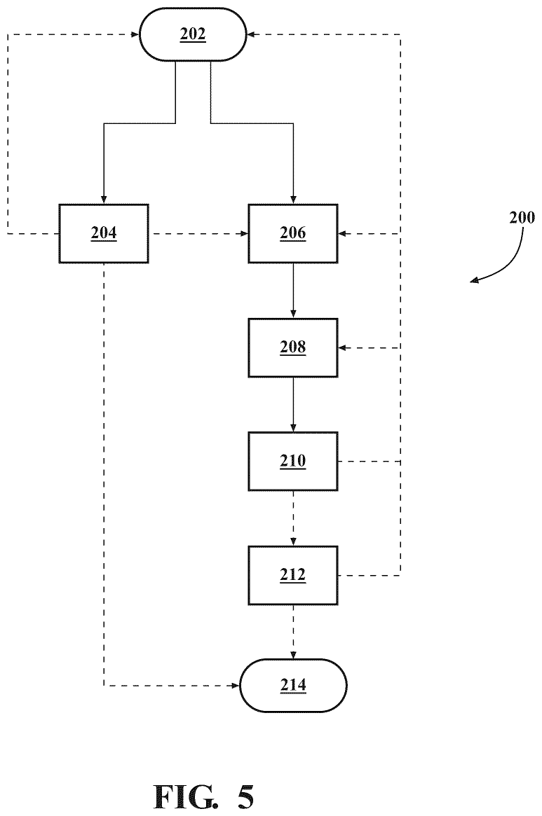

A method 200 of regenerating a chemical sensor via the sensor regeneration system 10 is shown in FIG. 5 and described below with reference to the structures shown in FIGS. 1-4. Specifically, method 200 is programmed into the ECU 20 to regenerate the primary chemical sensor 12, such as the CS-FET 124 in the application of the BMS 120, at the predefined regeneration temperature 28. Regeneration of the primary chemical sensor 12 is performed when the primary chemical sensor is not detecting presence of the chemical substance.

Method 200 commences in frame 202 with monitoring the confined environment 14 with the primary chemical sensor 12 with the intent of detecting the presence of a chemical substance. Following frame 202, the method advances to frame 204 or to frame 206. In frame 204, the method activates the first heating element 16 periodically, at a predetermined time interval 26, to regenerate the primary chemical sensor 12 at the predefined regeneration temperature 28. As noted above with respect to FIG. 1, the predetermined time interval 26 may be 60 seconds or greater. Following frame 204, the method may return to frame 202 or advance to frame 206. Alternatively, the method may proceed to frame 206 directly from frame 202.

In frame 206, the method includes monitoring a temperature of the primary chemical sensor 12 via the ECU 20, using the first temperature sensor 18 and operation of the first heating element 16. As described above with respect to FIGS. 1-4, the temperature detected by the first temperature sensor 18 may be determined, via the ECU 20, using the relationship 25 between electrical resistance of the first temperature sensor 18 and the primary chemical sensor's temperature programmed into the ECU. Additionally, as part of frame 206, the method may include monitoring over time, via the ECU 20, the electrical energy amount 34 consumed by the first heating element 16 to increase the temperature of the primary chemical sensor 12 to the target operating temperature 32. Following frame 206, the method advances to frame 208.

In frame 208, the method includes ascertaining, via the ECU 20, the presence of the contaminant 24 on the primary chemical sensor 12 using the monitored temperature of the primary chemical sensor and the operation of the first heating element 16. As part of frame 208, the method may include increasing, via the first heating element 16, the temperature of primary chemical sensor 12 to the target operating temperature 32 and thereby enabling detection of the chemical substance. Also, as part of frame 208, ascertaining the presence of the contaminant 24 on the primary chemical sensor 12 may be accomplished via assessment of heating efficiency of the first heating element 16.

As described above with respect to FIGS. 1-4, heating efficiency of the primary electrical sensor 12 may be assessed via determination of the electrical energy amount 34 consumed by the first heating element 16 to increase the temperature of the primary chemical sensor 12 to the target operating temperature 32. The presence of the contaminant 24 may then be ascertained by determining when the electrical energy amount 34 consumed by the first heating element 16 to increase the primary chemical sensor's temperature to the target operating temperature 32 is greater than the predefined threshold amount 36 of electrical energy.

Alternatively, the presence of the contaminant 24 may be ascertained in frame 208 via the contaminant sensor 40. In such an embodiment, the method may include monitoring, via the contaminant sensor 40, the confined environment 14 for the presence of contaminant 24. The contaminant sensor 40 may monitor the confined environment 14 during detection of the chemical substance 24 by the primary chemical sensor 12. In the subject embodiment, the method may also include detecting and communicating to the ECU 20, via the contaminant sensor 40, presence of the predefined concentration 42 of the contaminant 24 in the confined environment 14. From frame 208, the method moves on to frame 210.

In frame 210, the method includes activating, via the ECU 20, the first heating element 16 to regenerate the primary chemical sensor 12 in response to the ascertained presence of the contaminant 24. The first heating element 16 is specifically activated to help the primary chemical sensor 12 attain the predefined regeneration temperature 28 for the predetermined period of time 30. The subject activation of the first heating element 16 is intended to remove the contaminant 24 from the primary chemical sensor 12 and thereby regenerate the primary chemical sensor for renewed detection of the chemical substance.

The regeneration of the primary chemical sensor 12 is intended to be triggered when the primary chemical sensor 12 is not detecting the presence of chemical substance 24. The ECU 20 may trigger regeneration of the primary chemical sensor 12 in response to the detected presence of the predefined concentration 42 of the contaminant 24 in the confined environment 14 by the contaminant sensor 40. Following frame 210, the method may proceed to frame 212. In frame 212, the method includes regenerating, via the ECU 20, the contaminant sensor 40 using the second heating element 44, such as during detection of the presence of chemical substance by the primary chemical sensor 12.

Accordingly, as envisioned, method 200 enables continuous monitoring of the confined environment 14 and periodic regeneration of a chemical sensor, such as the CS-FET 124 in the BMS 120. Method 200 enables the subject sensor to maintain effective detection of a chemical substance, such as a gas vented by a Li-ion battery cell. Consequently, following either frame 210 or frame 212, the method may loop back to frame 202 for continued monitoring of the confined environment 14 and chemical substance detection via the primary sensor 12. Alternatively, following either frame 210 or frame 212, the method may loop back to frame 206 for continued monitoring of the primary sensor 12 to ascertain the presence of a contaminant on the subject sensor. In another alternative, following either frame 210 or frame 212, the method may loop back to frame 208 for continued monitoring of the contaminant sensor 40 to ascertain the presence of the contaminant in the confined environment 14. Otherwise, the method may conclude in frame 214.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework and the scope of the appended claims.

What is claimed is:

1. A sensor regeneration system comprising:
a primary chemical sensor arranged in a confined environment and configured to detect a presence of a chemical substance;
a first heating element arranged proximate the primary chemical sensor and configured to generate thermal energy to increase temperature of the primary chemical sensor;
a first temperature sensor arranged proximate the primary chemical sensor and configured to detect temperature of the primary chemical sensor; and
an electronic control unit (ECU) in operative communication with the primary chemical sensor, the first heating element, and the first temperature sensor;
wherein the ECU is configured to increase the temperature of the primary chemical sensor, via the first heating element, up to a predefined regeneration temperature when the primary chemical sensor is not detecting presence of the chemical substance and thereby regenerate the primary chemical sensor.

2. The sensor regeneration system of claim 1, wherein the ECU is configured to activate the first heating element periodically, at a predetermined time interval, to increase the temperature of the primary sensor up to the predefined regeneration temperature and thereby regenerate the primary chemical sensor.

3. The sensor regeneration system of claim 1, wherein the ECU is additionally configured to:
monitor the temperature of the primary chemical sensor via the first temperature sensor and operation of the first heating element;
ascertain presence of a contaminant on the primary chemical sensor using the monitored temperature of the primary chemical sensor and operation of the first heating element; and
activate the first heating element, when the primary chemical sensor is not detecting presence of the chemical substance, to increase the temperature of the primary sensor up to the predefined regeneration temperature for a predetermined period of time in response to the ascertained presence of the contaminant to remove the contaminant from the primary chemical sensor and thereby regenerate the primary chemical sensor.

4. The sensor regeneration system of claim 3, wherein the first heating element is configured to increase temperature of the primary chemical sensor to a target operating temperature and thereby enable detection of the chemical substance.

5. The sensor regeneration system of claim 4, wherein the ECU is configured to ascertain the presence of the contaminant on the primary chemical sensor via determining an amount of electrical energy consumed by the first heating element to increase the temperature of the primary chemical sensor to the target operating temperature.

6. The sensor regeneration system of claim 5, wherein the ECU is configured to:
monitor the amount of electrical energy consumed by the first heating element to increase the temperature of the primary chemical sensor to the target operating temperature; and
activate the first heating element to remove the contaminant from the primary chemical sensor when the amount of electrical energy consumed by the first heating element to increase the temperature of the primary chemical sensor to the target operating temperature is greater than a predefined threshold amount of energy.

7. The sensor regeneration system of claim 1, wherein the ECU is configured to determine the temperature detected by the first temperature sensor using a relationship between electrical resistance of the first temperature sensor and the temperature of the primary chemical sensor programmed into the ECU.

8. The sensor regeneration system of claim 1, further comprising a contaminant sensor in operative communication with the ECU and configured to:
monitor the confined environment for presence of the contaminant; and
detect and communicate to the ECU presence of a predefined concentration of the contaminant in the confined environment;
wherein the ECU is configured to activate the first heating element to increase the temperature of the primary sensor up to the predefined regeneration temperature in response to the detected presence of the predefined concentration of the contaminant.

9. The sensor regeneration system of claim 8, wherein the contaminant sensor includes a second heating element, and wherein the ECU is further configured to regenerate the contaminant sensor via the second heating element.

10. A sensor regeneration system comprising:
a sensor array microchip arranged in a confined environment and having:
a plurality of silicon chemical-sensitive field effect transistors (CS-FETs) configured to detect multiple distinct gases vented by a lithium-ion battery cell, wherein each CS-FET is configured to detect one of the gases vented by the lithium-ion battery cell and includes:
a first heating element configured to generate thermal energy to increase temperature of the subject CS-FET; and
a first temperature sensor configured to detect temperature of the subject CS-FET; and
an electronic control unit (ECU) in operative communication with each CS-FET of the sensor array microchip, the first heating element, and the first temperature sensor;
wherein the ECU is configured to activate the first heating element of one of the CS-FETs to increase the temperature of the subject CS-FET up to a predefined regeneration temperature when the subject CS-FET is not detecting presence of the corresponding gas and thereby regenerate the subject CS-FET.

11. The sensor regeneration system of claim 10, wherein the ECU is additionally configured to activate the first heating element of the subject CS-FET periodically, at a predetermined time interval, to increase the temperature of the subject CS-FET up to the predefined regeneration temperature and thereby regenerate the subject CS-FET.

12. The sensor regeneration system of claim 10, wherein the ECU is additionally configured to:
monitor the temperature of each CS-FET via the corresponding first temperature sensor and operation of the corresponding first heating element;
ascertain presence of a contaminant on each CS-FET using the monitored temperature of the subject CS-FET and operation of the corresponding first heating element; and
activate the first heating element of one of the CS-FETs, when the subject CS-FET is not detecting presence of the corresponding gas, to increase the temperature of the subject CS-FET up to the predefined regeneration temperature for a predetermined period of time in response to the ascertained presence of the corresponding gas to remove the contaminant from the subject CS-FET and thereby regenerate the subject CS-FET.

13. The sensor regeneration system of claim 12, wherein each first heating element is configured to increase temperature of the respective CS-FET to a target operating temperature and thereby enable detection of the corresponding gas.

14. The sensor regeneration system of claim 13, wherein the ECU is configured to ascertain the presence of the contaminant on each CS-FET via determining an amount of electrical energy consumed by the respective first heating element to increase the temperature of the corresponding CS-FET to the target operating temperature.

15. The sensor regeneration system of claim 14, wherein the ECU is configured to:
monitor the amount of electrical energy consumed by each first heating element to increase the temperature of the corresponding CS-FET to the target operating temperature; and
activate a respective heating element to remove the contaminant from the corresponding CS-FET when the amount of electrical energy consumed by the subject first heating element to increase the temperature of the subject CS-FET to the target operating temperature is greater than a predefined threshold amount of energy.

16. The sensor regeneration system of claim 10, wherein the ECU is configured to determine the temperature detected by a respective first temperature sensor using a relationship between electrical resistance of the subject first temperature sensor and the temperature of the corresponding CS-FET programmed into the ECU.

17. The sensor regeneration system of claim 10, further comprising a plurality of CS-FET contaminant sensors arranged on the sensor array microchip and in operative communication with the ECU,
wherein each CS-FET contaminant sensor:
corresponds to one of the CS-FETs and is configured to monitor the confined environment for presence of the contaminant and detect and communicate to the ECU presence of a predefined concentration of the contaminant in the confined environment; and
wherein the ECU is configured to activate the first heating element to increase the temperature of the corresponding CS-FET up to the predefined regeneration in response to the detected presence of the predefined concentration of the contaminant.

18. The sensor regeneration system of claim 17, wherein each contaminant CS-FET includes a second heating element, and wherein the ECU is further configured to regenerate each contaminant CS-FET via the corresponding second heating element.

19. A method of monitoring and regenerating a chemical sensor, the method comprising:
monitoring, via an electronic control unit (ECU) using a first temperature sensor and operation of a first heating element, a temperature of a primary chemical sensor arranged in a confined environment and configured to detect a presence of a chemical substance, wherein:
the first heating element is arranged proximate the primary chemical sensor and configured to generate thermal energy to increase temperature of the primary chemical sensor;
the first temperature sensor is arranged proximate the primary chemical sensor and configured to detect temperature of the primary chemical sensor; and
the ECU is in operative communication with the primary chemical sensor, the first heating element, and the first temperature sensor;
ascertaining, via the ECU, presence of a contaminant on the primary chemical sensor using the monitored temperature of the primary chemical sensor and the operation of the first heating element; and
activating, via the ECU, the first heating element, when the primary chemical sensor is not detecting presence of the chemical substance, to increase the temperature of the primary chemical sensor up to a predefined regeneration temperature for a predetermined period of time in response to the ascertained presence of the contaminant to remove the contaminant from the primary chemical sensor and thereby regenerate the primary chemical sensor.

20. The method of claim 19, further comprising increasing, via the first heating element, temperature of the primary chemical sensor to a target operating temperature and thereby enabling detection of the chemical substance.

21. The method of claim 20, wherein ascertaining the presence of the contaminant on the primary chemical sensor is accomplished via determining an amount of electrical energy consumed by the first heating element to increase the temperature of the primary chemical sensor to the target operating temperature.

22. The method of claim 21, further comprising:
monitoring, via the ECU, the amount of electrical energy (power) consumed by the first heating element to increase the temperature of the primary chemical sensor to the target operating temperature; and
activating, via the ECU, the first heating element to remove the contaminant from the primary chemical sensor when the amount of electrical energy consumed by the first heating element to increase the temperature of the primary chemical sensor to the target operating temperature is greater than a predefined threshold amount of energy.

23. The method of claim 19, wherein the temperature detected by the first temperature sensor is determined, via the ECU, using a relationship between electrical resistance of the first temperature sensor and the temperature of the primary chemical sensor programmed into the ECU.

24. The method of claim 19, further comprising:
monitoring, via a contaminant sensor, the confined environment for the presence of the contaminant;
detecting and communicating to the ECU, via the contaminant sensor, presence of a predefined concentration of the contaminant in the confined environment; and
activating the first heating element to increase the temperature of the primary chemical sensor up to the predefined regeneration temperature in response to the detected presence of the predefined concentration of the contaminant.

25. The method of claim 24, wherein the contaminant sensor includes a second heating element, the method further comprising regenerating, via the ECU, the contaminant sensor using the second heating element.
